(19) United States
(12) Patent Application Publication
(10) Pub. No.: US 2023/0146625 A1
(43) Pub. Date: May 11, 2023

(54) Cabinet Lock Device

(71) Applicant: Randal Ray Schanley, Camarillo, CA (US)

(72) Inventor: Randal Ray Schanley, Camarillo, CA (US)

(21) Appl. No.: 18/045,522

(22) Filed: Oct. 11, 2022

Related U.S. Application Data
(60) Provisional application No. 63/277,195, filed on Nov. 9, 2021.

(51) Int. Cl. E05B 65/44; E05B 9/08; E05B 15/00

(52) U.S. Cl. CPC E05B 65/44; E05B 9/08; E05B 15/00; E05Y 2900/20; E05Y 2201/10

(57) ABSTRACT

The present invention relates generally to the field of cabinet locks. More specifically, the present invention relates to a cabinet lock device primarily comprised of a pendulum housing, a latch housing, a catch housing release, and a door plate that can be attached to a rear door surface of a cabinet door. The door plate further receives the catch housing release. The pendulum and latch housing is further comprised of a latch and a pendulum wherein the pendulum activates a series of internal mechanisms within the pendulum and latch housing when movement of the cabinet is detected, which ultimately releases the latch into the catch housing release such that the cabinet door automatically locks in an automatic fashion. The catch housing release is further comprised of a release lever that can be used to unlock the cabinet from the outside after the device has been locked.

### CROSS-REFERENCE TO RELATED APPLICATION

The present application claims priority to, and the benefit of, U.S. Provisional Application No. 63/277,195 which was filed on Nov. 9, 2021, and is incorporated herein by reference in its entirety.

### FIELD OF THE INVENTION

The present invention relates generally to the field of cabinet locks. More specifically, the present invention relates to a cabinet lock device primarily comprised of a pendulum housing, a latch housing, a catch housing release, and a door plate catch housing that can be attached to a rear door surface of a cabinet door. The door plate further receives the latch housing release. The pendulum and latch housing is further comprised of a latch and a pendulum wherein the pendulum activates a series of internal mechanisms within the pendulum and latch housing when movement of the cabinet is detected, which ultimately releases the latch into the catch housing release such that the cabinet door automatically locks. The catch housing release is further comprised of a release lever that can be used to unlock the cabinet from the outside after the device has been locked. Accordingly, the present disclosure makes specific reference thereto. Nonetheless, it is to be appreciated that aspects of the present invention are also equally applicable to other like applications, devices, and methods of manufacture.

### BACKGROUND

During an earthquake, shut cabinet doors can be opened by the force of the earthquake. This may further lead to objects and items falling out of the cabinet. This may not only cause a disoganized mess that must be cleaned, a loss of property, and may also result in injury to nearby individuals who are struck by items or objects that fall out of cabinets.

Therefore, there exists a long-felt need in the art for an improved cabinet lock. There also exists a long-felt need in the art for a cabinet lock device that ensures a cabinet remains locked during an earthquake. In addition, there exists a long-felt need in the art for a cabinet lock device that ensures a cabinet remains locked during an earthquake or other natural disaster, wherein the device can be applied to any cabinet known in the art.

The subject matter disclosed and claimed herein, in one embodiment thereof, comprises a cabinet lock device. The device is primarily comprised of a pendulum and latch housing, a latch housing release, and a door plate catch. The door plate catch can be attached to a rear door surface of a cabinet door. The door plate catch further receives the latch housing. The pendulum and latch housing is further comprised of a latch and a pendulum. When movement of the cabinet is detected, the pendulum activates a series of internal mechanisms within the pendulum and latch housing that ultimately releases the latch into the door plate catch housing release such that the cabinet door automatically locks. The door plate catch housing release is further comprised of a release lever that can be used to unlock the cabinet from the outside after the device has been locked.

In this manner, the cabinet lock device of the present invention accomplishes all of the foregoing objectives and provides an improved cabinet lock. The device ensures a cabinet remains locked during an earthquake or other natural disaster. In addition, the device can be applied to any cabinet known in the art. Further, the cabinet remains unlocked to allow for ease of access when used daily, 24/7.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cabinet lock device. The device is primarily comprised of a pendulum housing, a latch housing release, and a door plate catch housing. The door plate can be secured to a rear door surface of a cabinet door via at least one fastener. The front surface of the door plate is further comprised of a catch receiving point that receives the latch housing release such that the catch housing release can be removably attached from the latch housing.

The body of the door plate catch housing release is comprised of at least one release lever, at least one internal latch catch, and at least one latch releasing member. The release lever is generally L-shaped such that it can contact the side surface of a cabinet door. The door plate catch housing release is further received by latch receiving point of the door plate. The release can be positioned left or right to suite the opening of the door.

The pendulum housing can be secured via at least one fastener to a top surface of a cabinet, wherein the pendulum housing and the latch housing houses a plurality of components including at least one internal anchor, at least one pendulum, at least one test button, at least one plunger, and at least one secondary magnetic lock. The housing further has at least one latch with at least one receiving point, as well as at least one spring.

Once secured to the top surface and door surface of a cabinet, the device automatically locks when an earthquake or other vibration event is detected. In this manner, the contents of a cabinet remain secured within the cabinet. Once locked, the device remains locked until a user activates the release lever.

To use the device, the inner components of pendulum housing and the latch housing can be armed and placed in an unlocked position wherein the internal anchor engages the receiving point of the latch to place the spring attached to the latch in tension. Any movement of the cabinet (i.e., due to vibrations from an earthquake) then causes the pendulum to swing, such that the plunger above the pendulum is pushed upwards and the spring tension on the internal anchor is released. The internal anchor then releases the latch which causes the latch to move forward and downward (i.e., away from the pendulum and latch housing) such that the latch engages the internal latch catch of the door plate catch housing. In this manner, the cabinet door remains closed and locked as the latch prevents the cabinet door from opening while within the door plate catch housing release (which is attached to the cabinet door via the door plate). This locking process occurs automatically and without the need for user intervention.

Accordingly, the cabinet lock device of the present invention is particularly advantageous as it provides an improved cabinet unlocked for ease of access and locks during an earthquake. In addition, the device can be applied to any cabinet known in the art. In this manner, the cabinet lock device overcomes the limitations of existing cabinet locks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings

### BRIEF DESCRIPTION OF THE DRAWINGS

The description refers to provided drawings in which similar reference characters refer to similar parts throughout the different views, and in which:

FIG. 1 illustrates a side view of one potential embodiment of a cabinet lock device of the present invention in a locked position in accordance with the disclosed architecture;

FIG. 2 illustrates a side view of one potential embodiment of a cabinet lock device and a cross-sectional view of the pendulum and latch housing of the present invention in an unlocked and armed position in accordance with the disclosed architecture;

FIG. 3 illustrates a side view of one potential embodiment of a cabinet lock device and a cross-sectional view of the pendulum and latch housing of the present invention in a locked position in accordance with the disclosed architecture;

FIG. 4 illustrates a cross-sectional side view of one potential embodiment of a cabinet lock device in a locked position in accordance with the disclosed architecture;

FIG. 5 illustrates a side view of one potential embodiment of a cabinet lock device of the present invention in a locked position within a cabinet in accordance with the disclosed architecture; and

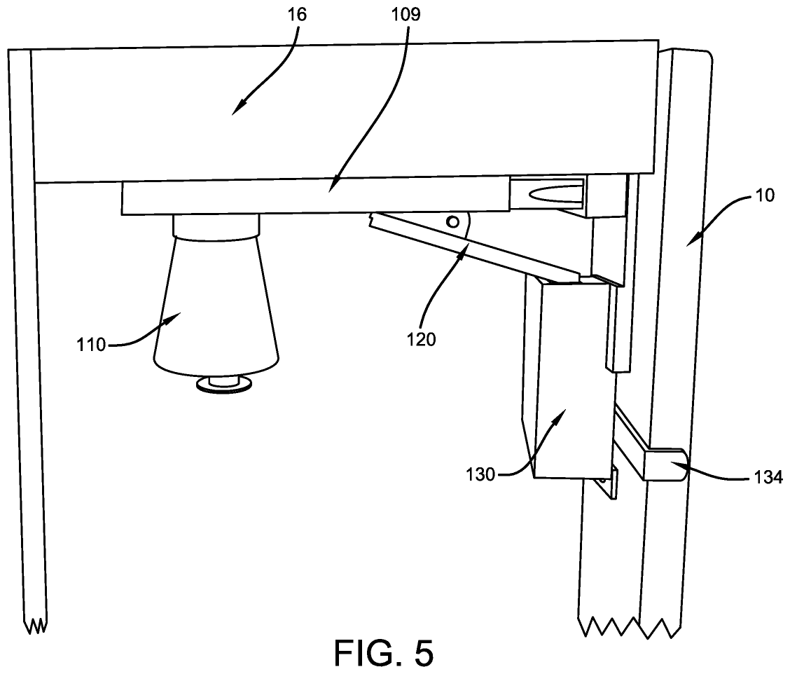

FIG. 6 illustrates a side view of one potential embodiment of a cabinet lock device of the present invention in an unlocked and armed position within a cabinet in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved cabinet lock. There also exists a long-felt need in the art for a cabinet lock device that ensures a cabinet remains locked during an earthquake or other natural disaster. In addition, there exists a long-felt need in the art for a cabinet lock device that ensures a cabinet remains locked during an earthquake, wherein the device can be applied to any cabinet known in the art.

The present invention, in one exemplary embodiment, is comprised of a cabinet lock device primarily comprised of a pendulum housing, a latch housing, a catch housing release, and a door plate. The door plate can be secured to a rear door surface of a cabinet door via at least one fastener. The front surface of the door plate catch housing is further comprised of a latch receiving point that receives the latch housing release such that the catch housing release can be removably attached to the door plate.

The body of the door plate catch housing release is comprised of at least one release lever, at least one internal latch catch, and at least one latch releasing member. The release lever is generally L-shaped such that it can contact the side surface of a cabinet door in a left or right position. The catch housing release is further received by the latch receiving point of the door plate catch housing.

The pendulum housing can be secured via at least one fastener to a top surface of a cabinet, wherein the pendulum housing and the latch housing houses a plurality of components including at least one internal anchor, at least one pendulum, at least one tester, at least one plunger, and at least one secondary magnetic lock. The pendulum and latch housing further has at least one latch with at least one receiving point, as well as at least one spring.

Once secured to the top surface and door surface of a cabinet, the device automatically locks when an earthquake or other vibration event is detected. As a result, the contents of a cabinet remain secured within the cabinet. Once locked, the device remains locked until a user activates the release lever.

To use the device, the inner components of the latch housing can be armed and placed in an unlocked position wherein the internal anchor engages the receiving point of the latch to place the spring attached to the latch in tension. Any movement of the cabinet (i.e., due to vibrations from an earthquake) then causes the pendulum to swing such that the plunger above the pendulum is pushed upwards such that the spring tension on the internal anchor is released. The internal anchor then releases the latch which causes the latch to move forward and downward (i.e., away from the pendulum and latch housing) such that the latch engages the internal latch catch of the catch housing release. In this manner, the cabinet door remains closed and locked as the latch prevents the cabinet door from opening while within the catch housing release (which is attached to the cabinet door via the door plate). This locking process occurs automatically and without the need for user intervention.

Accordingly, the cabinet lock device of the present invention is particularly advantageous as it provides an improved cabinet lock that remains locked during an earthquake. In addition, the device can be applied to any cabinet known in the art. In this manner, the cabinet lock device overcomes the limitations of existing cabinet locks known in the art.

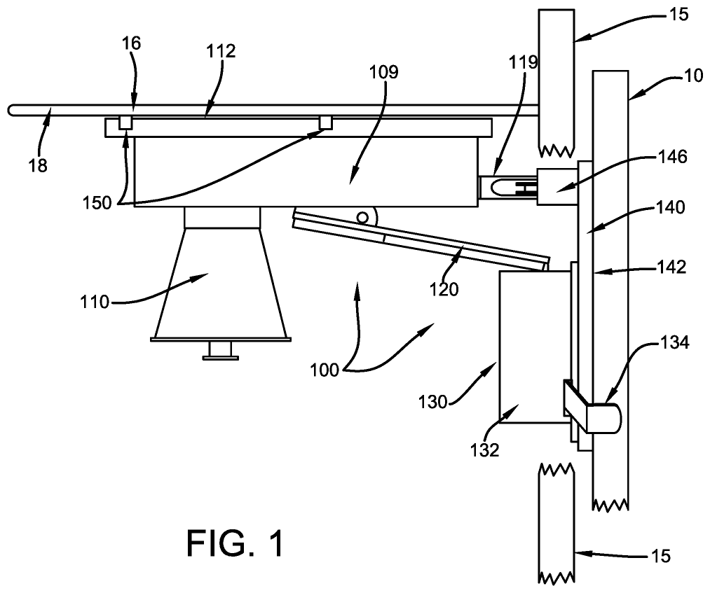

Referring initially to the drawings, FIG. 1 illustrates a side view of one potential embodiment of a cabinet lock device 100 of the present invention in a locked position in accordance with the disclosed architecture. The device 100 is primarily comprised of a pendulum housing 110, a latch housing 109, a catch housing release 130, and a door plate 140. In the preferred embodiment, all components of the device 100 are manufactured from a rigid or semi-flexible plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. or a durable metal such as aluminum.

The door plate 140 can be secured to a rear door surface 12 of a cabinet door 10 via at least one latch fastener 150 such as but not limited to screw, nail, adhesive, etc., that may be located on the rear door surface 142 of the door plate 140. The front surface of the door plate 140 is comprised of a secondary magnetic lock receiving point 146 that receives the catch housing release 130 such that the catch housing release 130 can be attached to the door plate 140. The door plate 140 is also comprised of a secondary magnetic lock receiving point 146 that receives a secondary magnetic lock 119 of the latch housing 109.

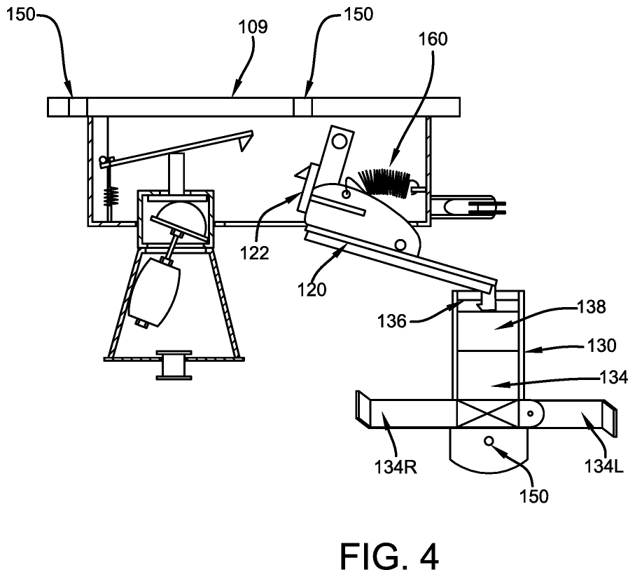

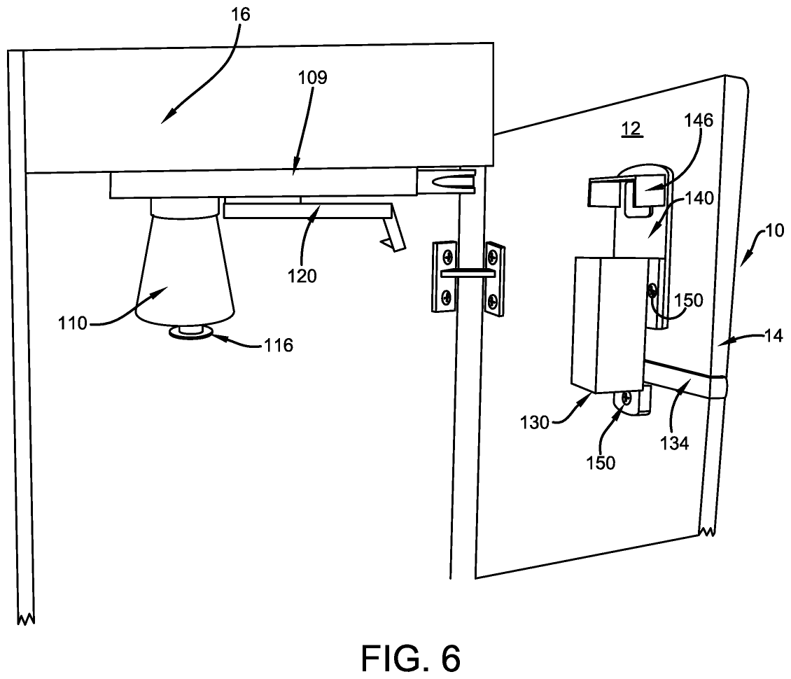

The body 132 of the catch housing release 130 is comprised of at least one release lever 134 in the Left or Right position to suite the opening of the Door 10, at least one internal latch catch 136 (as seen in FIG. 4), and at least one latch releasing member 138. The release lever 134 is preferably generally L-shaped such that it can contact the side surface 14 of a cabinet door 10 (as seen in FIG. 6). The catch housing release 130 is further received by the catch receiving point 146 of the door plate 140. The release lever 134 is comprised of a left side 134L or a right side 134R to suite the door opening.

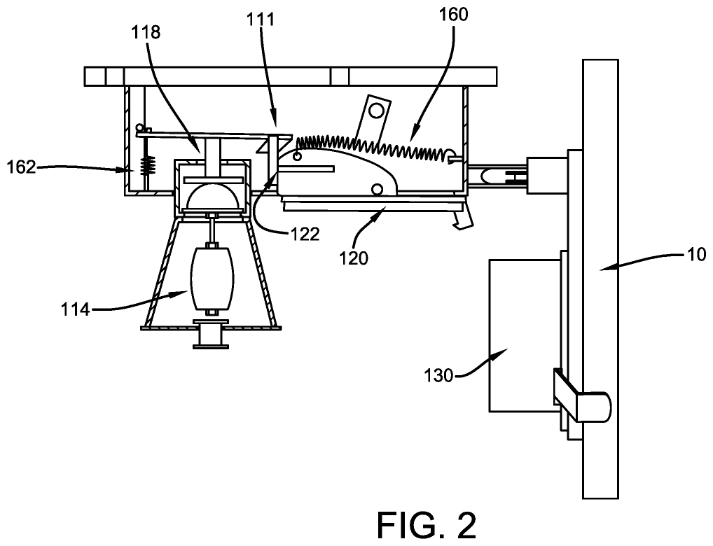

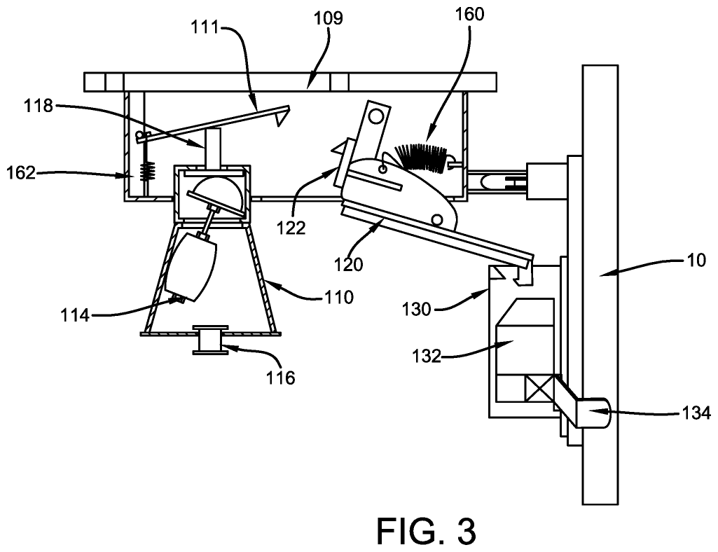

The pendulum and latch housing 109 & 110 can be secured via at least one latch fastener 150 to a top surface 18 of a cabinet surface 16. The latch housing 109 and the pendulum housing 110 houses a plurality of components including at least one internal anchor 111 (as seen in FIG. 2), at least one pendulum 114, at least one tester 116 (as seen in FIG. 3), at least one plunger 118 (as seen in FIGS. 2 & 3), and at least one secondary magnetic lock 119 (on FIG. 1) located on the outside of the pendulum and latch housing 109 & 110 which is received by the secondary magnetic lock receiving point 146 of the door plate 140. In the preferred embodiment, the secondary magnetic lock 119 is magnetic, but may be any lock type known in the art that can be securely received by the secondary magnetic lock receiving point 146 to provide additional locking power to the device 100. The latch housing 109 further has at least one latch 120 with at least one receiving point 122, as well as at least one spring 160.

Once secured to the top surface 18 and rear door surface 12 of a cabinet 16 (as seen in FIG. 6), the device 100 automatically locks when an earthquake or other vibration event is detected. In this manner, the contents of a cabinet remain secured within the cabinet. Once locked, the device 100 remains locked until a user activates the release lever 134 thereby releasing the door 10.

To use the device, the inner components of the pendulum housing 110 and latch housing 109 can be armed and placed in an unlocked position. In an armed position, the internal anchor 111 engages the receiving point 122 of the latch 120 to place the spring 160 attached to the latch 120 in tension, (as seen in FIG. 2). Any movement of the cabinet (i.e., due to vibrations from an earthquake) then causes the pendulum 114 to swing such that the plunger 118 above the pendulum 114 is pushed upwards and the spring 160 tension on the internal anchor 111 is released. This then causes the internal anchor 111 to release the latch 120. Once the latch 120 is released, it moves forward and downward (i.e., away from the pendulum and latch housing 109 & 110) such that the latch 120 engages the internal latch catch 136 of the catch housing release 130, (as seen in FIG. 3 and FIG. 4). In this manner, the cabinet door 10 remains closed and locked as the latch 120 prevents the cabinet door 10 from opening while within the catch housing release 130 (which is attached to the cabinet door 10 via the door plate 140). This locking process occurs automatically and without the need for user intervention. To reset the latch 120, a user need only push up vertically (i.e., towards the top surface 112) and away from the rear door surface 12 of the cabinet door 10 horizontally such that the internal anchor 111 re-engages the receiving point 122 of the latch 120, (as seen in FIG. 6).

To unlock the cabinet door 10, a user can slide the release lever 134 along the side surface 14 of the cabinet door 10 from outside the cabinet 16. This moves the release lever 134 upwards within the catch housing release 130 such that a latch releasing member 138 (as seen in FIG. 4 & 6) is pushed upwards by the movement of the release latch 134 such that the latch 120 disengages the internal latch catch 136 and the cabinet door 10 can be opened. A test button 116 can be used to check the function of the pendulum 114 as needed by moving upwards into the pendulum 114 when pressed (which then releases the latch 120 as noted above).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cabinet lock device” and “device” are interchangeable and refer to the cabinet lock device 100 of the present invention.

Notwithstanding the foregoing, the cabinet lock device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cabinet lock device 100 as shown in the (FIGS). are for illustrative purposes only, and that many other sizes and shapes of the cabinet lock device 100 are well within the scope of the present disclosure. Although the dimensions of the cabinet lock device 100 are important design parameters for user convenience, the cabinet lock device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprised” as “comprising” is interpreted when employed as a transitional word in a “claim” as claims”.

What is claimed is:

1. A cabinet lock device comprising:
a pendulum housing;
a latch housing;
a pendulum;
a latch;
a catch housing release;
an internal latch catch;
a release lever; and
a door plate comprised of a catch receiving point.
The cabinet lock device of claim 1, wherein the catch receiving point receives the catch housing release.
The cabinet lock device of claim 2, wherein the catch housing release receives the latch.
The cabinet lock device of claim 3, wherein a vertical movement of the release lever removes the latch from the catch housing release.
A cabinet lock device comprising:
a pendulum housing;
a latch housing;
a pendulum;
a plunger;
an internal anchor;
a spring;
a latch;
a catch housing release;
an internal latch catch;
a latch releasing member;
a release lever; and
a door plate comprised of a catch receiving point.
The cabinet lock device of claim 5, wherein the catch receiving point receives the catch housing release.
The cabinet lock device of claim 6, wherein the catch housing release receives the latch.
The cabinet lock device of claim 7, wherein the latch engages the internal latch catch.
The cabinet lock device of claim 5, wherein a vertical movement of the release lever removes the latch from the catch housing release.
The cabinet lock device of claim 5, wherein the pendulum is positioned below the plunger.
A cabinet lock device comprising:
a pendulum housing;
a latch housing;
a pendulum;
a plunger;
a test button;
an internal anchor;
a spring;
a secondary magnetic lock;
a latch;
a catch housing release;
an internal latch catch;
a latch releasing member;
a release lever; and
a door plate comprised of a catch receiving point and a secondary magnetic lock receiving point.
The cabinet lock device of claim 1, wherein the secondary magnetic lock is magnetic.
The cabinet lock device of claim 11, wherein the latch is comprised of a receiving point.
The cabinet lock device of claim 13, wherein the spring is attached to the latch.
The cabinet lock device of claim 11 further comprised of a fastener.
The cabinet lock device of claim 11, wherein the pendulum is positioned below the plunger.
The cabinet lock device of claim 11, wherein the test button tests the function of the pendulum.
The cabinet lock device of claim 11, wherein the secondary magnetic lock receiving point receives the secondary magnetic lock of the latch housing.
The cabinet lock device of claim 11, wherein a movement of the release lever unlocks the cabinet lock device.
The cabinet lock device of claim 11, wherein a movement of the release lever releases the latch from the catch housing release.
